(19) United States
(12) Patent Application Publication
(10) Pub. No.: US 2005/0073866 A1
(43) Pub. Date: Apr. 7, 2005

(54) Boost converters, power supply apparatuses, electrical energy boost methods and electrical energy supply methods

(76) Inventor: John Cummings, Round Rock, TX (US)

Correspondence Address: WELLS ST. JOHN P.S., 601 W. FIRST AVENUE, SUITE 1300, SPOKANE, WA, 99201, US

(21) Appl. No.: 10/681,089

(22) Filed: Oct. 7, 2003

(51) Int. Cl. H01M 14/00

(52) U.S. Cl. 363/63

(57) ABSTRACT

Boost converters, power supply apparatuses, electrical energy boost methods and electrical energy supply methods are described. According to one aspect, a boost converter includes an input configured to receive direct current electrical energy at a first voltage, an output configured to output direct current electrical energy at a second voltage higher than the first voltage, a plurality of switching devices coupled in series intermediate a positive terminal of the output and a ground, wherein one of the switching devices comprises a high side switching device coupled with the positive terminal and the other of the switching devices comprises a low side switching device coupled with the ground, drive circuitry configured to output a common control signal to control switching of the plurality of switching devices, a capacitor configured to capacitively couple the common control signal from the drive circuitry to the high side switching device, and wherein the control signal is configured to control the switching of the switching devices to boost the voltage of the received electrical energy of the first voltage to the second voltage.

### TECHNICAL FIELD

This invention relates to boost converters, power supply apparatuses, electrical energy boost methods and electrical energy supply methods.

### BACKGROUND OF THE INVENTION

The sophistication and uses of electrical devices have increased dramatically in recent years. Consumer items having electrical components are ubiquitous in communications, computing, entertainment, etc. The size of mobile telephones, notebook computers, music players, and other devices has continued to decrease while the capabilities and quality of the devices continues to increase as modern electronic components used in such devices are developed and improved upon.

Numerous people rely upon or have grown accustomed to usage of electrical consumer devices for business, education, or for other needs. Electronic consumer devices are increasingly portable to accommodate these needs during travels from home or the workplace. The sophistication and capabilities of power supplies for such devices have also improved to meet the requirements of the electronic consumer devices. For example, cost, size, and capacity are some product characteristics which have been improved for the portable power supplies for electronic applications.

There is a desire to enhance these and other design parameters of power supplies, including portable power supplies, to accommodate increasing power requirements of modern electronic consumer devices. Some power supplies utilize boost circuitry to increase the voltage of electrical energy stored using batteries of the power supplies. Some boost circuits are largely inefficient, perhaps providing losses of 40% or more during boost operations. At least some aspects of the disclosure provide improved methods and apparatus for supplying electrical energy.

### BRIEF DESCRIPTION OF THE DRAWINGS

Preferred embodiments of the invention are described below with reference to the following accompanying drawings.

FIG. 1 is an illustrative representation of an exemplary power supply apparatus according to one embodiment.

FIG. 2 is an illustrative representation of exemplary internal components of the power supply apparatus illustrated in FIG. 1.

FIG. 3 is a functional block diagram illustrating components of an exemplary power supply apparatus according to one embodiment.

FIG. 4 is a schematic diagram of an exemplary boost converter of a power supply apparatus according to one embodiment.

FIG. 5 is a graph illustrating current waveforms of current conducted using low side and high side switching devices of the boost converter according to one embodiment.

FIG. 6 is a graph illustrating current waveforms of current conducted using a blocking diode and high side switching device of the boost converter according to one embodiment.

FIG. 7 is a graph illustrating exemplary voltage waveforms applied to gates of the low side and high side switching devices according to one embodiment.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

According to one embodiment, a boost converter comprises an input configured to receive direct current electrical energy at a first voltage, an output configured to output direct current electrical energy at a second voltage higher than the first voltage, a plurality of switching devices coupled in series intermediate a positive terminal of the output and a ground, wherein one of the switching devices comprises a high side switching device coupled with the positive terminal and the other of the switching devices comprises a low side switching device coupled with the ground, drive circuitry configured to output a common control signal to control switching of the plurality of switching devices, a capacitor configured to capacitively couple the common control signal from the drive circuitry to the high side switching device, and wherein the control signal is configured to control the switching of the switching devices to boost the voltage of the received electrical energy of the first voltage to the second voltage.

According to another embodiment, a power supply apparatus comprises a first coupling configured to couple with a supply and to receive electrical energy from the supply to charge electrochemical storage circuitry, a second coupling configured to couple with a load, a boost converter comprising a plurality of switching devices controlled by a common control signal to implement regulation of direct current electrical energy of a first voltage from the electrochemical storage circuitry to a second voltage greater than the first voltage, and wherein the second coupling is configured to provide the direct current electrical energy of the second voltage to the load.

According to yet another embodiment, a power supply apparatus comprises electrochemical storage means for providing direct current electrical energy at a first voltage, first interface means for coupling with a supply and for receiving electrical energy from the supply for use in charging the electrochemical storage means, boost converter means for regulating the direct current electrical energy from the electrochemical storage circuitry to a second voltage greater than the first voltage, wherein the boost converter comprises synchronous field effect transistor means for increasing the voltage of the direct current electrical energy from the first voltage to the second voltage, and second interface means for coupling with a load and for providing the direct current electrical energy of the second voltage to a load.

According to an additional embodiment, an electrical energy boost method comprises providing direct current electrical energy at a first voltage, first conducting the electrical energy of the first voltage using an inductor, second conducting a first portion of the first conducted electrical energy using a first switching device, third conducting a second portion of the first conducted electrical energy using a second switching device, and wherein only one of the second conducting and the third conducting substantially occurs at a given moment in time to boost the voltage of the direct current electrical energy to a second voltage greater than the first voltage.

According to still another embodiment, an electrical energy supply method comprises storing direct current electrical energy using an electrochemical storage device, providing the stored electrical energy at a first voltage, inductively coupling the provided electrical energy to a plurality of switching devices, controlling the switching devices to operate according to a break-before-make mode of operation to increase a voltage of the provided direct current electrical energy to a second voltage greater than the first voltage, and using an output, outputting the direct current electrical energy at the second voltage to a load.

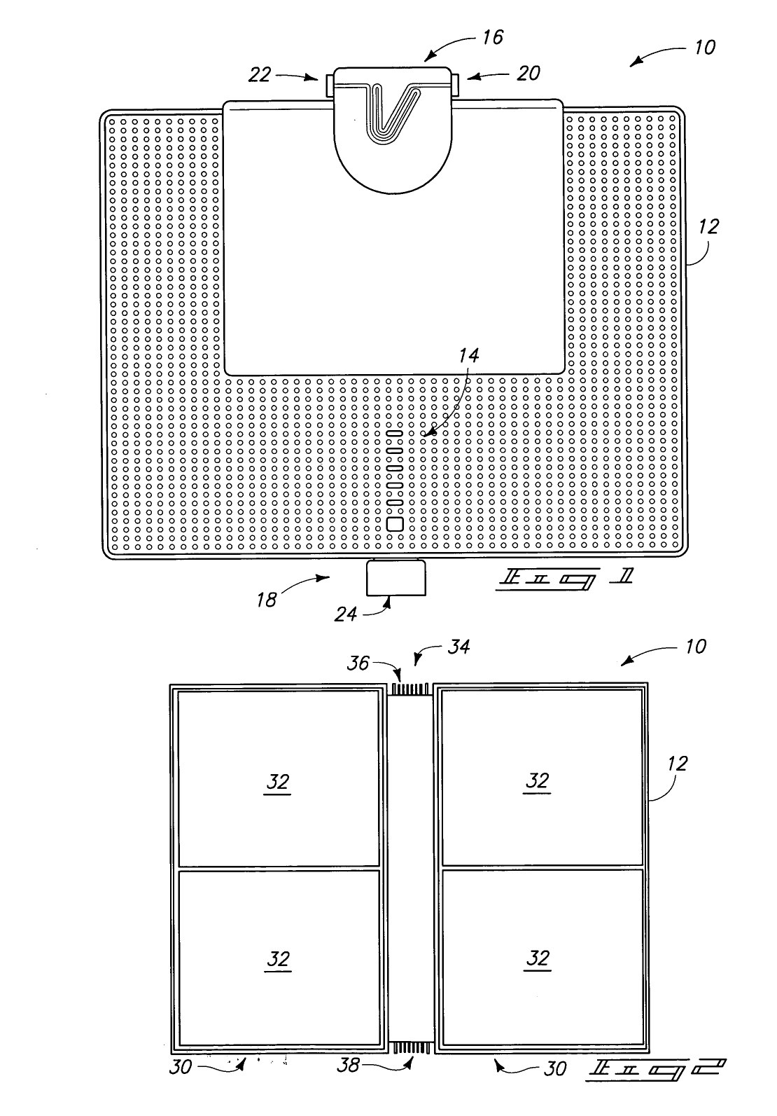

Referring to FIG. 1, an exemplary arrangement of a power supply apparatus 10 according to one embodiment is shown. Power supply apparatus 10 is arranged to provide electrical energy to one or more load (not shown in FIG. 1). In at least one aspect, power supply apparatus 10 is arranged to provide high-power electrical energy to high-power loads having power ratings, for example, in excess of 20 watts (and having exemplary operational voltages of 16-20 Volts or more) and low-power electrical energy to low-power loads having power ratings, for example, less than 20 watts (and having exemplary operational voltages less than 12 Volts).

In exemplary applications, power supply apparatus 10 is arranged as a portable device configured to provide portable electrical energy to portable loads or devices. Exemplary high-power loads include notebook computers and exemplary low-power loads include personal digital assistants (PDAs), mobile telephones, etc. Power supply apparatus 10 may be utilized to provide electrical power to other devices or may be configured in other arrangements to power devices of other wattage ratings. The particular arrangement of power supply apparatus 10 may be modified and tailored to accommodate the energy requirements of the utilized load(s). Power supply apparatus 10 may be utilized to provide electrical energy to one load (e.g., one high-power load or low-power load) at a given moment in time, or simultaneously provide electrical energy to one or more high-power load or one or more low-power load. Other arrangements besides portable energy applications including permanent arrangements or semi-permanent arrangements for providing electrical energy may also be implemented.

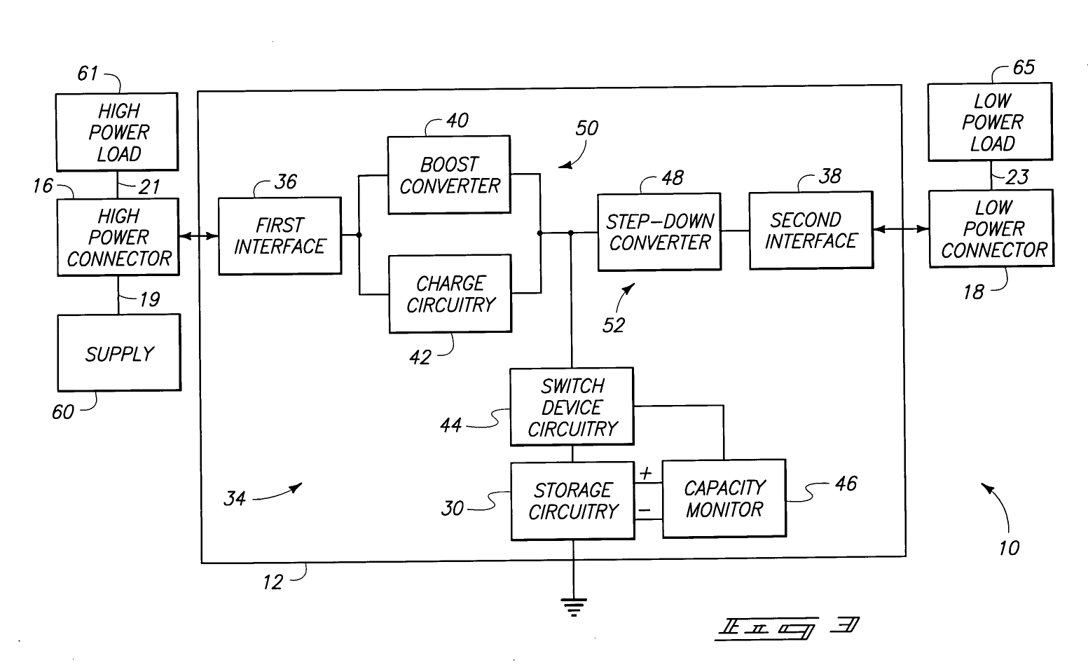

The illustrated exemplary power supply apparatus 10 includes a housing 12 configured to house electrical energy storage circuitry (exemplary storage circuitry is shown in FIG. 2). The depicted arrangement of power supply apparatus 10 shown in FIG. 1 includes one or more indicator 14 configured to provide charge status information of storage circuitry and\or power supply apparatus 10. In the depicted exemplary embodiment, indicator 14 is implemented as a plurality of light emitting diodes (LEDs).

The depicted power supply apparatus 10 further includes a first connector 16 and a second connector 18. First connector 16 and second connector 18 are configured to couple with external devices or loads and to supply electrical energy to loads coupled therewith and\or receive electrical energy from a supply coupled therewith. Connectors 16, 18 have appropriate receptacle(s) to accommodate cables or other couplings utilized for coupling with the respective individual loads and\or supply. In the depicted exemplary arrangement, first connector 16 includes a receptacle 20 configured to receive a cable or other connection to couple with an external supply (not shown) and a second receptacle 22 configured to receive a cable or other connection for coupling with a load. Connector 18 includes a receptacle 24 which is configured to couple with a load in the illustrated configuration.

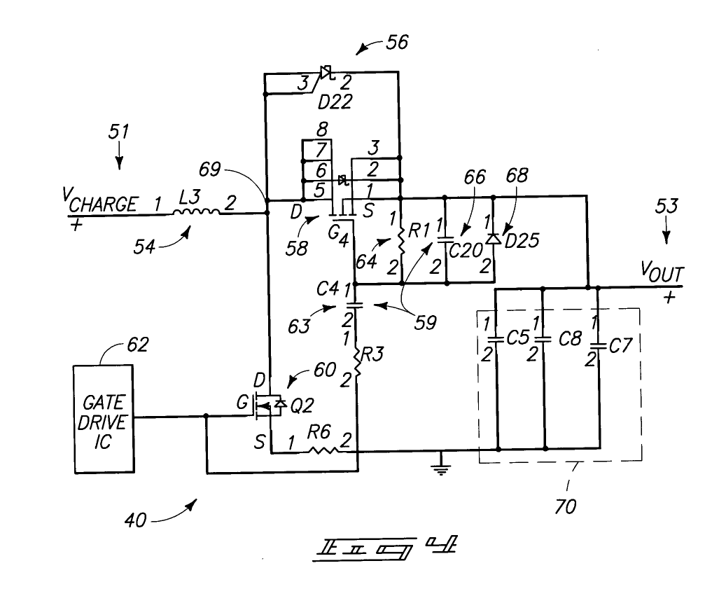

An appropriate supply (shown in FIG. 3) can comprise any convenient source of electrical power, such as a utility line, generator, alternator, etc. If the supply is implemented as an alternating current supply, a rectifier (not shown) may be utilized to provide direct current electrical energy. Power supply apparatus 10 is configured to provide such received electrical energy to a load coupled with receptacle 22 and\or to utilize such received electrical energy to charge storage circuitry of apparatus 10. Electrical energy stored within power supply apparatus 10 may also be provided to a load coupled with receptacle 22 or to a load coupled with second connector 18.

As mentioned previously, power supply apparatus 10 is arranged to supply electrical power to loads of different configurations and having different energy ratings or requirements for proper operation. For example, a first load may require or utilize electrical energy of a first voltage while another appropriate load may utilize electrical energy of a second voltage. In the described exemplary configuration, first connector 16 is a high-power connection and second connector 18 is a low-power connection.

A plurality of possible connectors 16, 18 are available to provide appropriate connection of power supply apparatus 10 with respective loads. Once a load is identified, the appropriate connector corresponding thereto is selected by the user and utilized to couple apparatus 10 with the load and\or supply. Connectors 16, 18 are configured to provide appropriate electrical energy to corresponding load devices and also configure power supply apparatus 10 as described further below.

Referring to FIG. 2, additional details of an exemplary power supply apparatus 10 are described. The depicted arrangement of power supply apparatus 10 includes electrical energy storage circuitry 30 configured to receive, store and supply electrical energy.

Storage circuitry 30 includes one or more electrochemical device 32 in exemplary embodiments. In the illustrated arrangement of FIG. 2, four electrochemical devices 32 are provided and are coupled in series to form a battery. According to one embodiment of the invention, electrochemical devices 32 are individually implemented as a lithium cell having a lithium-mixed metal electrode. Further details regarding an exemplary lithium cell having a lithium-mixed metal electrode are discussed in U.S. patent application Ser. No. 09/484,799, entitled “Lithium-based Active Materials and Preparation Thereof”, listing Jeremy Barker as an inventor, filed Jan. 18, 2000, and incorporated herein by reference.

A particular configuration of power supply apparatus 10 may be dictated by an application in which it will be used to supply electrical energy. Electrochemical devices 32 implemented as lithium cells individually having a lithium-mixed metal electrode are individually configured in at least one arrangement to provide a voltage of approximately 3.7 Volts in a substantially charged state or condition. In the depicted exemplary arrangement, four electrochemical devices 32 are coupled in series to provide electrical energy to an appropriate load. In such a configuration, electrical energy is provided at a variable voltage range of 8 to 14.8 Volts from storage circuitry 30 with a nominal voltage of 10-13.2 Volts during typical operations.

In another possible embodiment, two banks of devices 32 are coupled in parallel to provide the electrical energy. Individual banks may include four such electrochemical devices 32 arranged in series. In an exemplary configuration comprising four series arranged electrochemical devices 32, power supply apparatus 10 may be utilized in 60 watt applications. In the configuration including eight electrochemical devices 32, power supply apparatus 10 may be utilized to provide electrical energy in 130 watt applications. Other configurations of power supply apparatus 10 including more or less cells arranged in series and\or parallel are contemplated and may be utilized in other energy applications having other energy current, voltage or wattage specifications.

Power supply apparatus 10 additionally includes circuitry 34 configured to control and monitor operations of apparatus 10. For example, circuitry 34 controls and implements charging, maintenance, and discharging of electrochemical devices 32 as well as conditioning of electrical energy extracted from electrochemical devices 32.

Exemplary circuitry 34 includes a first interface 36 and a second interface 38. First and second interfaces 36, 38 are individually configured to electrically couple with a respective one of first connector 16 and second connector 18. In the depicted exemplary embodiment, first and second interfaces 36, 38 comprise a plurality of electrical connection pins configured to mate with respective electrical connections such as receptacles (not shown) of connectors 16, 18. Connectors 16, 18 and interfaces 36, 38 are configured for removable electrical coupling enabling different configurations of first and second connectors 16, 18 to be utilized with the power supply apparatus 10 and corresponding to the loads and supplies to be coupled with apparatus 10. Further details regarding exemplary operations and one possible arrangement of circuitry 34 and apparatus 10 are discussed in a co-pending patent application having patent application Ser. No. 10/072,827, filed Feb. 8, 2002, entitled “Power Supply Apparatuses and Methods of Supplying Electrical Energy,” listing Lawrence Stone and John Cummings as inventors, the teachings of which are incorporated by reference herein.

Referring to FIG. 3, operations of one exemplary embodiment of power supply apparatus 10 are described with respect to a plurality of components of circuitry 34 of apparatus 10. The depicted electrical components of circuitry 34 are illustrated within housing 12 in the described arrangement. Such may be implemented using a printed circuit board.

In accordance with one exemplary embodiment, circuitry 34 includes storage circuitry 30, first interface 36, second interface 38, a boost converter 40, charge circuitry 42, switch device circuitry 44, a capacity monitor 46, and a step-down converter 48. Components intermediate switch device circuitry 44 and first interface 36 may be referred to as high-power circuitry 50 and components intermediate switch device circuitry 44 and second interface 38 may be referred to as low-power circuitry 52.

As shown in FIG. 3, first interface 36 is configured to removably electrically couple with connector 16, which may comprise a high-power connector, and second interface 38 is configured to removably electrically couple with connector 18, which may be referred to as a low-power connector. Connector 16 is coupled via a coupling 19 with a supply 60, such as an AC adapter providing rectified electrical energy, and via a coupling 21 with a high-power load 61, such as a notebook computer in the illustrated arrangement. Low-power connector 18 is coupled via a coupling 23 with a low-power load 65, such as a mobile telephone, PDA, etc.

Interfaces 36, 38 are coupled with and provide electrical energy from storage circuitry 30 to respective loads 61, 65 using respective connectors 16, 18. In addition, first interface 36 is arranged in the exemplary embodiment to receive electrical energy from supply 60 coupled with connector 16. Further, interfaces 36, 38 may be arranged to receive control signals from connectors 16, 18 which control operations of circuitry 34 (e.g., voltage conversion operations).

Supply 60 and storage circuitry 30 provide electrical energy for usage within high-power load 61 and/or low-power load 65. Referring to operations of circuitry 50, one or both of supply 60 and high-power load 61 may be coupled with connector 16 at any given time.

Boost converter 40 is coupled intermediate storage circuitry 30 and first interface 36. Boost converter 40 is configured to receive direct current (DC) electrical energy from storage circuitry 30 and to provide direct current electrical energy having an increased voltage. According to an exemplary embodiment wherein storage circuitry 30 includes four series coupled lithium cell electrochemical devices 32, electrical energy having a nominal voltage of 10-13.2 Volts is provided and received by boost converter 40. Exemplary high-power loads (e.g., notebook computers) utilize electrical energy at a voltage of approximately 19.4 Volts. Boost converter 40 in one exemplary configuration increases the voltage of electrical energy received from storage circuitry 30 (e.g., 10 Volts) to electrical energy having an increased voltage (e.g., 19.4 Volts). In one configuration, boost converter 40 comprises synchronous circuitry. Additional details regarding an exemplary boost converter 40 are described below with respect to FIG. 4.

Charge circuitry 42 is configured to control and implement charging and conditioning operations of storage circuitry 30. Charge circuitry 42 is coupled intermediate first interface 36 and storage circuitry 30 including one or more electrochemical device 32. In an exemplary configuration, charge circuitry 42 is implemented as a current sense circuit having product designation LT1621 available from Linear Technology Corporation and a battery charger having product designation LTC1735 available from Linear Technology Corporation.

Charge circuitry 42 is configured to monitor a quantity of electrical energy supplied from supply 60 to high-power load 61. Responsive to such monitoring, charge circuitry 42 controls a supply of electrical energy from supply 60 to storage circuitry 30 to charge one or more electrochemical device 32. Charge circuitry 42 is arranged in the described configuration to assure that load 61 receives adequate electrical energy for proper operation.

Capacity monitor 46 is configured to monitor a state of charge of electrochemical devices 32 of storage circuitry 30. Capacity monitor 46 is coupled with switch device circuitry 44 and is configured to control such switch device circuitry 44 responsive to the monitoring. In one embodiment, switch device circuitry 44 includes a charge field effect transistor (FET) and a discharge field effect transistor which are controlled to implement charging, discharging and maintenance operations. In one arrangement, capacity monitor 46 is implemented using product designation BQ2060, available from Texas Instruments Incorporated.

As illustrated in FIG. 3, electrical energy is provided for utilization within low-power load 65. The depicted exemplary configuration of low-power circuitry 52 includes step-down converter 48 intermediate switch device circuitry 44 and second interface 38. Step-down converter 48 is operable to provide electrical energy having different electrical characteristics (e.g., electrical energy of different voltages) corresponding to particular loads 65 coupled with second interface 38 similar to converter 40.

Step-down converter 48 is arranged to receive electrical energy from electrochemical device 32, to decrease a voltage of the electrical energy received from electrochemical device 32, and to provide the electrical energy of the decreased voltage to second interface 38 for application to load 65 coupled therewith. Connector 18 controls the outputted voltage of converter 48 in the described embodiment.

In the described arrangement, circuitry 34 is arranged to apply electrical energy from supply 60 to storage circuitry 30 to charge and\or maintain electrochemical devices 32 and to apply electrical energy from storage circuitry 30 to first interface 36 and\or second interface 38 for application to respective present loads 61, 65. Converters 40, 48 are configured to receive electrical energy which may have a variable voltage from storage circuitry 30 and to provide regulated electrical energy of a substantial constant voltage for application to respective loads 61, 65.

Although converter 40 is configured as a boost converter and converter 48 is configured as a step-down converter in the described exemplary embodiment, the converters 40, 48 may be individually configured to implement other conditioning operations corresponding to the respective loads 61, 65. For example, converter 40 may be arranged to reduce the voltage of received electrical energy and converter 48 may be arranged to increase the voltage of received electrical energy in other exemplary embodiments.

Referring to FIG. 4, a boost converter 40 according to one configuration is shown. Boost converter 40 comprises an input 51 configured to receive direct current electrical energy at a first voltage and an output 53 configured to output direct current electrical energy at a second voltage greater than the first voltage. The illustrated boost converter 40 further includes an inductor 54, blocking diode 56, a first switching device 58, a second switching device 60, drive circuitry 62, a capacitor 63, a resistor 64, a capacitor 66, a diode 68, and output filtering circuitry 70. A common node 69, also referred to as a switching node, couples a drain of second switching device 60 with a drain of first switching device 58. Inductor 54 is coupled intermediate a positive terminal of input 51 and node 69 and is configured to supply electrical energy from storage circuitry 30 to the common node 69.

Vcharge may correspond to input direct current electrical energy from storage circuitry 30 and Vout corresponds to output direct current electrical energy applied to first interface 36. The voltage of the received electrical energy corresponds to the configuration and state of charge of storage circuitry 30 and may have a nominal voltage of 10-13.2 Volts while the output electrical energy is regulated to a constant output voltage of approximately 19.4 Volts in the exemplary arrangement. Other voltages may be used in other embodiments.

Blocking diode 56 may be utilized to accommodate different gate charges for the first and the second switching devices 58, 60 and the different rates of switching of devices 58, 60. In one embodiment, blocking diode 56 is implemented as a Schottky diode.

First switching device 58 may comprise a high side field effect transistor (FET) implemented as a P-Channel device. In the described embodiment, the first switching device 58 may comprise a synchronous device, such as a synchronous FET or synchronous rectifier. Second switching device 60 may comprise a low side field FET implemented as an N-Channel device in the exemplary embodiment. Switching devices 58, 60 are coupled in series intermediate a positive terminal of the output 53 and a ground as shown in FIG. 4.

Drive circuitry 62 comprises a gate drive integrated circuit configured to control the operation of switching devices 58, 60 to implement boost operations in one implementation. In the illustrated embodiment, drive circuitry 62 outputs a common control signal comprising a square wave of 0-5 Volts at a frequency of 600 kHz which controls both of the switching devices 58, 60 (i.e., the gate drive of first switching device 58 is derived from the gate drive for the second switching device 60) to boost the voltage of the direct current electrical energy received via input 51.

In one embodiment, boost converter 40 is arranged such that only one of first switching device 58 having a negative threshold voltage and second switching device 60 having a positive threshold voltage are substantially enabled at a given time. This avoids simultaneous engagement of both switching devices 58, 60 which would short the output voltage and disable the ability of boost converter 40 to regulate the output voltage.

In the disclosed embodiment, voltage translation capacitor 63 operates to ensure only one of switching devices 58, 60 is substantially engaged at any given time. In the exemplary embodiment of FIG. 4, N-Channel FET switching device 60 utilizes a positive voltage threshold of the gate with respect to the source to form a channel and conduct. P-Channel FET switching device 58 utilizes a negative voltage at the gate with respect to the source to form a channel and conduct. Voltage translation capacitor 63 operates to capacitively couple the common control signal and the gate of switching device 58 to provide voltage translation operations wherein the voltage of the gate drive signal is translated to the output voltage (Vout) plus the voltage drop of diode 68 enabling the common gate drive signal to control operation of switching devices 58, 60 of opposite polarity types (e.g., comprising P and N channel devices) and wherein device 60 is referenced to ground and device 58 is referenced to Vout.

During a negative pulse from drive circuitry 62, switching device 58 is inherently OFF inasmuch as the voltage of the gate of switching device 58 is substantially pulled up to the voltage of the source (i.e., the output voltage). When a positive pulse is provided by drive circuitry 62, translation capacitor 63 causes the gate of switching device 58 to rise by an equal amount (e.g., 5 Volts). However, the actual voltage rise is limited by diode 56 and a capacitive divider 59 comprising capacitors 63, 66.

When the voltage on the gate of switching device 60 is driven to 0 Volts (i.e., the charge pulled off of the gate), the translation capacitor 63 causes the voltage at the gate of switching device 58 to fall. The resultant voltage at the gate of switching device 58 is a function of the capacitive divider 59.

In the disclosed embodiment, switching device 58 comprises a P-Channel FET configured to facilitate break-before-make operation with respect to switching device 60 wherein the P-Channel FET is easier to turn on and off compared with switching device 60. For example, in the depicted embodiment, device 58 uses less gate charge compared with device 60 and the current is flowing in the direction of the body diode providing zero-voltage switching of device 58. In the exemplary break-before-make configuration, switching device 58 is substantially OFF before switching device 60 is substantially ON. As the switching device 58 turns off, current is automatically shunted through the external blocking diode 56.

Referring to the operation of switching device 60, when device 60 is OFF there is a voltage Vds across the drain and source which is nominally the regulation voltage of the converter 40. When sufficient gate charge is applied to turn device 60 ON, the device begins to conduct and the voltage Vds falls. As the voltage Vds falls below Vgs, a parasitic Miller capacitor of second switching device 60 creates a brief delay in the turn on switching because the falling Vds pulls charge off of the gate via the Miller capacitor. This delay provides sufficient time for first switching device 58 to be completely OFF before engagement of switching device 60 providing break-before-make operation.

Further protection of simultaneous engagement of devices 58, 60 is provided by first switching device 58 having a lower gate charge than second switching device 60 and/or switching device 58 configured to implement zero voltage switching in one embodiment. Accordingly, switching speed of first switching device 58 is inherently faster than the switching speed of second switching device 60 in at least one embodiment.

In addition, capacitor 66 may be selected to have a sufficient capacitance to swamp out or over-ride switching effects of the parasitic Miller capacitor of first switching device 58 arranged as a FET in a zero-voltage switching arrangement in combination with diode 56. For example, capacitor 66 having capacitance 0.01 μF is sufficient in the embodiment of FIG. 4 to render the value of the parasitic capacitor of device 58 negligible. Moreover, capacitive divider 59 limits the total voltage drop of Vgs of first switching device 58 which further ensures first switching device 58 is disabled prior to re-engagement of second switching device 60.

Diode 68 is configured to ensure that the gate of first switching device 58 does not go to more than a diode drop higher than Vout. This allows for the gate of the first switching device 58 in the disclosed embodiment to fall as much as 2.5 Volts when the second switching device 60 is disabled and assuming capacitors 63, 66 are sufficiently matched and there was a 5 Volt gate drive removed from the second switching device 60.

Accordingly, the described exemplary configuration of the boost converter 40 provides break-before-make operations during first switching device 58 going from ON to OFF states and second switching device 60 going from OFF to ON states. In the described configuration, a self-protect operation is further provided wherein first switching device 58 is turned OFF if node 69 joining first and second switching devices 58, 60 falls below Vout. This self-protect operation results from the fact that pull-up current of the gate of first switching device 58 comes from the source of device 58. Further, break-before-make operations are implemented during device 60 turning OFF and device 58 turning ON. For example, device 60 becomes sufficiently resistive before a channel adequately forms within device 58 and current is initially momentarily directed through diode 56 providing the break-before-make operation.

The described exemplary boost converter 40 provides negligible switching losses inasmuch as the first switching device 58 comprising a synchronous FET is effectively a zero-voltage switched device and therefore not subject to the switching losses caused by the parasitic Miller capacitor of device 58 implemented as a FET in but one arrangement. The disclosed exemplary boost converter 40 has provided real world testing to deliver 90 W of power at more than 93% conversion efficiency. At more reasonable and typical loads of 45-60 W, the efficiency is in excess of 94%.

Exemplary circuit components of the boost circuitry 40 of FIG. 4 are provided in Table A. Other configurations and components are possible.

TABLE A

| Component | Part No. | Vend r | Valu | |
|---|---|---|---|---|
| Inductor 54 | — | — | 4.7 | μH |
| Diode 56 | MBR745 | Fairchild | — | |
| | | Semiconductor | | |
| FET 58 | FDS6675 | Fairchild | — | |
| | | Semiconductor | | |
| FET 60 | ISL9N302AS3ST | Fairchild | — | |
| | | Semiconductor | | |
| Drive IC 62 | LTC1871 | Linear Technology | — | |
| | | Corp | | |
| Capacitor 63 | — | — | 0.01 | μF |
| Resistor 64 | — | — | 330 | Ω |
| Capacitor 66 | — | — | 0.01 | μF |
| Diode 68 | BAT54 | Fairchild | — | |
| | | Semiconductor | | |
| Resistor R6 | — | — | 0.01 | Ω |
| Capacitors C5, C7, | — | — | 0.01 | μF |
| C8 | | | | |

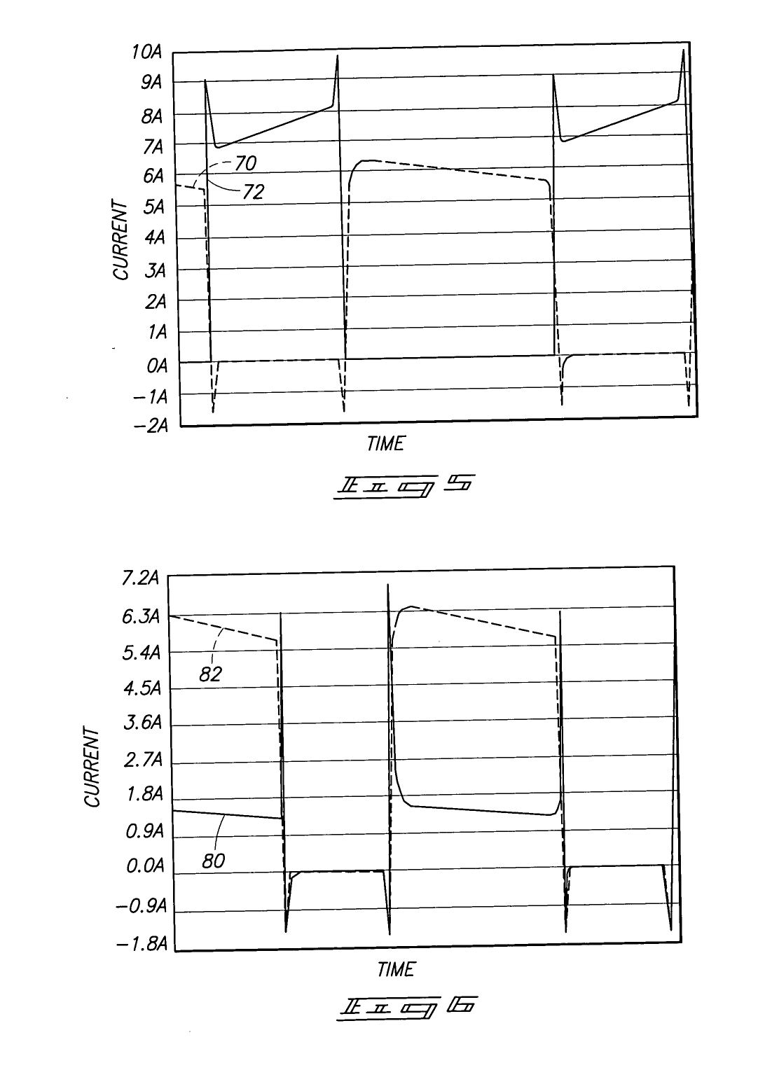

Referring to FIG. 5, a graphical representation of current flowing through first and second switching devices 58, 60 during ON and OFF states is shown. Waveform 70 corresponds to current conducted by first switching device 58 and waveform 72 corresponds to current conducted by second switching device 60. As shown, only one of the switching devices 58, 60 is substantially conducting at any given time during voltage boost operations illustrating exemplary break-before-make switching operations of devices 58, 60.

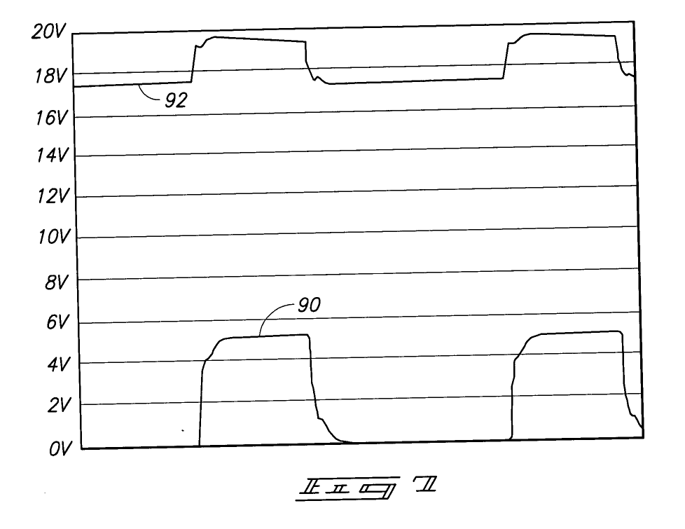

Referring to FIG. 6, a graphical representation of current flowing through blocking diode 56 and first switching device 58 during ON and OFF states of device 58 is shown. Waveform 80 corresponds to the current of blocking diode 56 and waveform 82 corresponds to the current of first switching device 58. Blocking diode 56 conducts significant current only at times when first switching device 58 is engaged or disengaged corresponding to the different switching rates of devices 58, 60 (e.g., device 60 switches faster than device 58) thereby drastically reducing losses through blocking diode 56 providing improved efficiency.

Referring to FIG. 7, a graphical representation of voltages applied to gates of first switching device 58 and second switching device 60 are shown. Waveform 90 represents the voltage at the gate of second switching device 60 (corresponding to the outputted square wave of the drive circuitry 62), and waveform 92 represents the translated voltage of the first switching device 58.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A boost converter comprising:
an input configured to receive direct current electrical energy at a first voltage;
an output configured to output direct current electrical energy at a second voltage higher than the first voltage;
a plurality of switching devices coupled in series intermediate a positive terminal of the output and a ground, wherein one of the switching devices comprises a high side switching device coupled with the positive terminal and the other of the switching devices comprises a low side switching device coupled with the ground;
drive circuitry configured to output a common control signal to control switching of the plurality of switching devices;
a capacitor configured to capacitively couple the common control signal from the drive circuitry to the high side switching device; and
wherein the control signal is configured to control the switching of the switching devices to boost the voltage of the received electrical energy of the first voltage to the second voltage.

2. The converter of claim 1 wherein only one of the first and the second switching devices is substantially conducting during voltage boost operations of the boost converter.

3. The converter of claim 1 wherein the high side switching device comprises a synchronous device.

4. The converter of claim 1 wherein the high side switching device and the low side switch device are configured in a break-before-make configuration.

5. The converter of claim 1 wherein the high side switching device is configured to provide zero-voltage switching.

6. The converter of claim 1 wherein the high side switching device uses less gate charge compared to implement switching compared with the low side switching device.

7. The converter of claim 1 wherein the high side switching device comprises a P-Channel field effect transistor and the low side switching device comprises an N-Channel field effect transistor.

8. The converter of claim 7 wherein a gate of the P-Channel field effect transistor receives pull-up current from a source of the P-Channel field effect transistor and wherein the P-Channel field effect transistor is turned OFF if a node coupling the high and low side switching devices falls below the second voltage to provide self-protection.

9. The converter of claim 7 further comprising a capacitor coupled with a gate and a source of the P-Channel switching device and configured to over-ride switching effects of a parasitic Miller capacitor of the P-Channel field effect transistor.

10. The converter of claim 1 wherein the capacitor is configured to provide voltage translation of the common control signal enabling the common control signal to control the switching devices of opposite polarity type.

11. A power supply apparatus comprising:
a first coupling configured to couple with a supply and to receive electrical energy from the supply to charge electrochemical storage circuitry;
a second coupling configured to couple with a load;
a boost converter comprising a plurality of switching devices controlled by a common control signal to implement regulation of direct current electrical energy of a first voltage from the electrochemical storage circuitry to a second voltage greater than the first voltage; and
wherein the second coupling is configured to provide the direct current electrical energy of the second voltage to the load.

12. The apparatus of claim 11 further comprising the electrochemical storage circuitry comprising a lithium cell having a lithium-mixed metal electrode.

13. The apparatus of claim 11 further comprising:
a third coupling; and
a step-down converter configured to receive direct current electrical energy from the electrochemical storage circuitry, to decrease a voltage of the electrical energy received from the electrochemical storage circuitry, and to provide the electrical energy of the decreased voltage to the third coupling for application to an other load coupled with the third coupling.

14. The apparatus of claim 11 wherein the boost converter is configured to provide operation of the switching devices wherein only one of the switching devices is substantially electrically conducting at a given moment in time during voltage boost operations.

15. The apparatus of claim 11 wherein the switching devices are coupled in series intermediate a positive terminal of the second coupling and a ground, and further comprising an inductor configured to supply electrical energy from the electrochemical storage circuitry to a common node of the switching devices.

16. The apparatus of claim 15 wherein the switching device coupled with the positive terminal comprises a synchronous device.

17. The apparatus of claim 11 wherein one of the switching devices comprises a first conductivity type and an other of the switching devices comprises a second conductivity type.

18. The apparatus of claim 17 wherein the one switching device comprises a P-Channel field effect transistor and the other switching device comprises an N-Channel field effect transistor.

19. The apparatus of claim 18 wherein the P-Channel field effect transistor and N-Channel field effect transistor are configured in a break-before-make configuration wherein the P-Channel switching device is substantially OFF before the N-Channel switching device is substantially ON.

20. The apparatus of claim 11 wherein the switching devices are configured in a break-before-make configuration wherein one of the switching devices is substantially OFF before the other of the switching devices is substantially ON.

21. The apparatus of claim 11 wherein the boost converter comprises a voltage translation capacitor configured to provide voltage translation of the common control signal before application to one of the switching devices.

22. The apparatus of claim 21 further comprising a capacitive divider coupled with the voltage translation capacitor and comprising substantially matched capacitors configured to ensure one of the switching devices comprising a high side switching device is substantially OFF before another of the switching devices comprising a low side switching device is substantially ON.

23. The apparatus of claim 21 wherein the switching devices comprise devices of opposite polarity type.

24. A power supply apparatus comprising:
electrochemical storage means for providing direct current electrical energy at a first voltage;
first interface means for coupling with a supply and for receiving electrical energy from the supply for use in charging the electrochemical storage means;
boost converter means for regulating the direct current electrical energy from the electrochemical storage circuitry to a second voltage greater than the first voltage, wherein the boost converter comprises synchronous field effect transistor means for increasing the voltage of the direct current electrical energy from the first voltage to the second voltage; and
second interface means for coupling with a load and for providing the direct current electrical energy of the second voltage to a load.

25. The apparatus of claim 24 wherein the first and the second interface means are embodied within a single connector means for providing electrical energy from the supply to the load.

26. The apparatus of claim 24 wherein the electrochemical storage means comprises at least one lithium cell having a lithium-mixed metal electrode.

27. The apparatus of claim 24 wherein the synchronous field effect transistor means comprises high side switching means and the boost converter means further comprises low side switching means, and the boost converter means comprises means for providing operation wherein only one of the high and low side switching devices is substantially electrically conducting during voltage boost operations.

28. The apparatus of claim 27 wherein the boost converter means comprises drive means for providing a common control signal to control switching of the high side and the low side switching means.

29. The apparatus of claim 28 wherein the boost converter means comprises voltage translation means for translating a voltage of the control signal before application thereof to the high side switching means.

30. An electrical energy boost method comprising:
providing direct current electrical energy at a first voltage;
first conducting the electrical energy of the first voltage using an inductor;
second conducting a first portion of the first conducted electrical energy using a first switching device;
third conducting a second portion of the first conducted electrical energy using a second switching device; and
wherein only one of the second conducting and the third conducting substantially occurs at a given moment in time to boost the voltage of the direct current electrical energy to a second voltage greater than the first voltage.

31. The method of claim 30 wherein the providing comprises providing using an electrochemical storage device.

32. The method of claim 30 wherein the providing comprises providing using an electrochemical storage device comprising at least one lithium cell having a lithium-mixed metal electrode.

33. The method of claim 30 further comprising controlling the first and the second switching devices using a common control signal to implement the second and the third conductings.

34. The method of claim 33 wherein the controlling comprises voltage translating the common control signal, and the controlling of one of the first and the second switching devices comprises controlling using the voltage translated common control signal.

35. The method of claim 30 wherein the first switching device comprises a high side device implemented as a synchronous device.

36. An electrical energy supply method comprising:
storing direct current electrical energy using an electrochemical storage device;
providing the stored electrical energy at a first voltage;
inductively coupling the provided electrical energy to a plurality of switching devices;
controlling the switching devices to operate according to a break-before-make mode of operation to increase a voltage of the provided direct current electrical energy to a second voltage greater than the first voltage; and
using an output, outputting the direct current electrical energy at the second voltage to a load.

37. The method of claim 36 wherein the controlling comprises controlling only one of the switching devices to substantially conduct electrical energy at a given moment in time.

38. The method of claim 36 wherein the controlling comprises controlling using a common control signal.

39. The method of claim 38 wherein one of the switching devices comprises a high side switching device coupled with a positive terminal of the output, and the controlling comprises capacitively coupling the common control signal with the high side switching device.

40. The method of claim 36 wherein one of the switching devices comprises a high side switching device coupled with a positive terminal of the output, and the high side switching device comprises a synchronous field effect transistor.

41. The method of claim 36 wherein the storing comprises storing using at least one lithium cell having a lithium-mixed metal electrode.
